(19) United States
(12) Patent Application Publication
(10) Pub. No.: US 2017/0231191 A1
(43) Pub. Date: Aug. 17, 2017

(54) MULTIFUNCTIONAL INTELLIGENT FEEDING CONTROL DEVICE

(71) Applicants: Tianle Yang, Zhongshan (CN); Yibao Zeng, Zhongshan (CN)

(72) Inventors: Tianle Yang, Zhongshan (CN); Yibao Zeng, Zhongshan (CN)

(21) Appl. No.: 15/169,687

(22) Filed: May 31, 2016

(30) Foreign Application Priority Data
Feb. 17, 2016 (CN) 201620125225.4
Feb. 17, 2016 (CN) 201620125798.7

(51) Int. Cl. A01K 5/01; A01K 15/02; A01K 29/00

(52) U.S. Cl. CPC A01K 5/0114; A01K 29/00; A01K 15/024; A01K 15/025

(57) ABSTRACT

The present invention discloses a multifunctional intelligent feeding control device, comprising: a base and a feeding control dish, the feeding control dish being detachably mounted on the base, an edge of the base fastened with the feeding control dish being a flange; a accommodating space is formed between the feeding control dish and the base which are well mounted; at least one through hole is formed on the feeding control dish; and a connecting member with a ventilation function is provided above and also connected to the feeding control dish. The multifunctional intelligent feeding control device of the present invention has low manufacturing cost, smaller packaging volume due to a dismountable and mountable design, convenience for storage and reduced cost of transportation.

### CROSS-REFERENCE TO RELATED APPLICATIONS

The present application claims the benefit of Chinese Utility Model Application No. 201620125225.4 filed on Feb. 17, 2016 and Chinese Utility Model Application No. 201620125798.7 filed on Feb. 17, 2016, the contents of which are hereby incorporated by reference.

### TECHNICAL FIELD

The present invention relates to the field of pet supplies, in particular to a multifunctional intelligent feeding control device.

### BACKGROUND OF THE PRESENT INVENTION

With the development of economy and the improvement of living standards, more and more people began to feed pets, the required pet supplies are more and more abundant, and are increasingly developed in a trend to increase the interest of pets and benefit the physical and mental health of pets.

According to the survey, at present, 34% of pets are overweight in the world, and obesity will cause muscle tissue diseases, skeleton disorders, cardiovascular disorders and the like, and will also break down the immune system, resulting in the lack of patience during the activities of pets. At present, eating too fast is one of the main reasons for leading to the obesity, and will further lead to a series of digestive disorders. Therefore, the current priority is to research and develop a novel feeding device which can control the eating speed of pets and which has a function of entertainment.

### SUMMARY OF THE PRESENT INVENTION

In view of this, it is necessary to provide a multifunctional intelligent feeding control device to solve the above problems.

In order to achieve the objective, the technical solution employed by the present invention is as follows.

The multifunctional intelligent feeding control device of the present invention includes: a base and a feeding control dish, the feeding control dish being detachably mounted on the base, an edge of the base fastened with the feeding control dish being a flange; an accommodating space is formed between the feeding control dish and the base which are well mounted; at least one through hole is arranged on the feeding control dish; and a connecting member with a ventilation function is provided above and also connected to the feeding control dish.

Further, a turnup, which is folded upward, is provided on the periphery of the base for preventing food from dropping.

Further, an annular groove is formed between the flange and the turnup, the annular groove being used as a ball rolling track for toys to roll thereon.

Further, the base and the feeding control dish are both made of hard material which is melamine or plastic.

Further, the bottom of the base is provided with a plurality of non-slip mats made of silicone rubber material for preventing the base from moving during the pets' eating or playing.

Further, the connecting member includes at least one feeding control insert; the feeding control dish is a plane or a concave plane, and the feeding control insert is respectively arranged in the through hole; and a plurality of small holes, configured to spread a smell, are formed on the surface of the feeding control insert. The concave plane is provided with a check ring on the edge thereof in the same way.

As another solution, the connecting member is a scratching post, the feeding control dish is a concave plane having a check ring on an edge thereof, the concave plane is provided with through holes, and the scratching post is mounted on the concave plane.

Further, there is a gap between the bottom of the feeding control insert and the edge of the through hole, so that the feeding control insert still may be rotated after being inserted into the through hole.

Further, the feeding control insert is an elastic insert prepared from silica gel or TPR soft material.

Further, the feeding control insert is in a shape of fishtail, bone or plant.

Further, at least one mounting column is arranged at the back of the feeding control dish, and at least one mounting hole is arranged on the surface of the base; the mounting column and the mounting hole are mounted and connected correspondingly.

Further, the mounting column is arranged on the edge of the concave plane, and the mounting hole is arranged on the inside edge of the flange of the base; and the mounting column and the mounting hole are mounted and connected correspondingly.

The beneficial effect of the present invention is as follows.

The present invention has ingenious design, simple structure and low manufacturing cost, can effectively control the amount of food intake of pets and also can be provided for the pets to play with, thereby arousing the interest of pets in eating, training the intelligence of pets, and also enabling the owner to be free from companying pets to do other things. The feeding control insert is made of elastic material, so that the pets may have good tactile impression, and the eating experience of pets is effectively improved. Meanwhile, the feeding control device has smaller packaging volume due to a dismountable and mountable design, convenience for storage and reduced cost of transportation. The feeding control device can be combined in a variety of ways and thus widely applied.

### BRIEF DESCRIPTION OF THE DRAWINGS

FIG. 1 is an exploded view of a feeding control device of the present invention;

FIG. 2 is another exploded view of the feeding control device of the present invention; and

FIG. 3 is a third exploded view of the feeding control device of the present invention, in which:

1: base

11: turnup

12: mounting hole

13: food tray

2: feeding control dish

21: through hole

211: concave plane

212: check ring

213: through hole

22: scratching post

23: accommodating space

3: feeding control insert

4: non-slip mat.

### DETAILED DESCRIPTION OF THE PRESENT INVENTION

In order to make the objectives, technical solutions and the advantages of the present invention more clear, the technical solutions of the present invention will be further described in detail by embodiments of the present invention. It should be noted that the embodiments described here are just some but not all of the embodiments of the present invention. Based on the embodiments of the present invention, all other embodiments obtained by those skilled in the art without paying any creative effort belong to the protection scope of the present invention.

### Embodiment

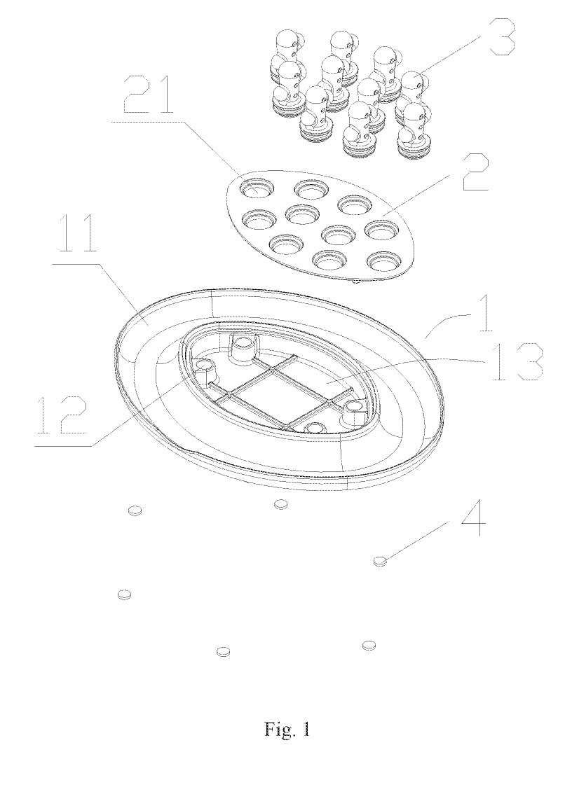

As shown in FIG. 1 to FIG. 3, a multifunctional intelligent feeding control device is provided, including a base 1 and a feeding control dish 2, the feeding control dish 2 is detachably mounted on the base 1, and an accommodating space 23 is formed between the feeding control dish 2 and the base 1 which are well mounted; and at least one through hole 21 is arranged on the feeding control dish 2.

A plurality of mounting columns are arranged on the bottom of the feeding control dish 2, and a plurality of mounting holes are arranged on the upper surface of the base 1; the mounting columns and the mounting holes are mounted and fixed in such a way of matching one by one, so that the feeding control dish 2 and the base 1 may be detachably fastened and fixed to each other.

A turnup 11, which is folded upward, is provided on the periphery of the base 1 for preventing food from dropping.

An edge of the portion of the base 1 fastened with the feeding control dish 2 is a flange, an annular groove is formed between the turnup 11 and the flange, and the annular groove is used as a ball rolling track for toys to roll thereon.

The center of the base 1 is similar to a food tray 13 used by a person to accommodate food, and the food tray 13 has a high edge and a low center; and a plurality of mounting holes are arranged on the edge of the food tray 13. When the feeding control dish 2 and the base 1 are fastened to each other, an accommodating space 23, configured to accommodate objects such as catnip and snacks giving off a smell, is formed between the feeding control dish 2 and the base 1, thereby attracting the pets to come over for eating and playing. An annular recess between the turnup 11 and the food tray 13 may also be used as a ball rolling track.

A plurality of through holes 21 are formed on the feeding control dish 2.

As one of the solutions, the feeding control dish 2 is a plane (as shown in FIG. 1); and the feeding control device of the present invention includes at least one feeding control insert 3, and the feeding control insert 3 is correspondingly inserted into the through hole, respectively. A plurality of small holes, configured to spread a smell, are formed on the surface of the feeding control insert 3.

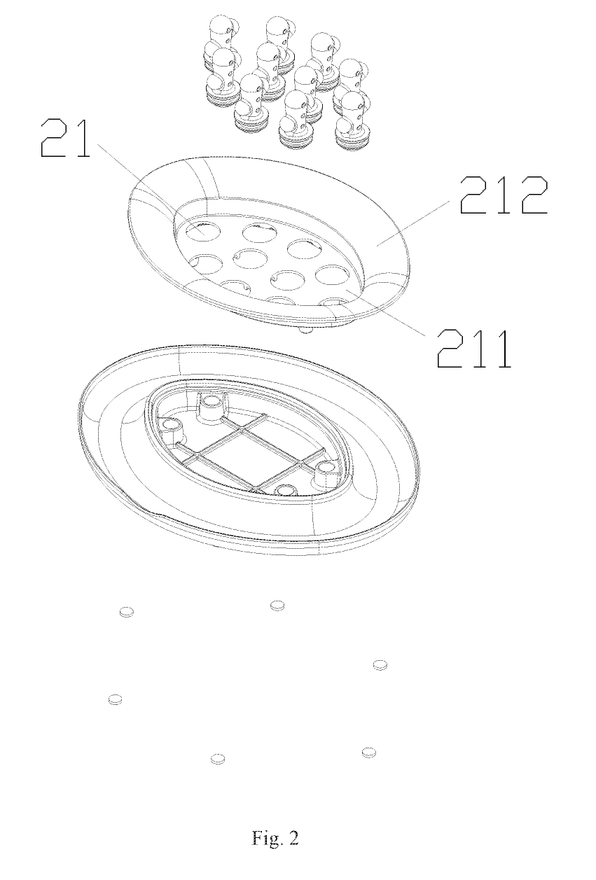

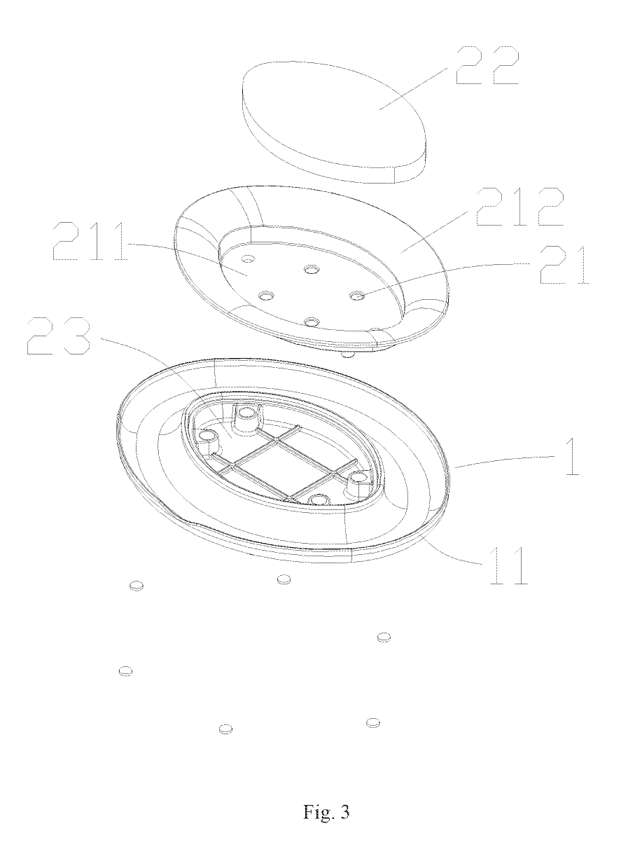

The present invention may also have another variation, where the feeding control dish 3 is a concave plane 211 (as shown in FIG. 2 and FIG. 3) having a check ring 212 on an edge thereof, in order to form a shape of traditional disc or dish; and the concave plane 211 is similarly designed with through holes 21 which may be matched and connected to the feeding control inserts 3, or is not provided with a feeding control insert 3 but is mounted with a scratching post 22; and the scratching post 22 is preferably a paper board.

When the feeding control dish 3 is a concave plane 211, there is another preferable way for mounting the base 1 and the food tray 13: a radial size of the concave plane 211 is smaller than that of the base 1, and is equivalent to that of the food tray 13 of the base 1, so that the concave plane 211 is fastened on the food tray 13 to form an accommodating space 23. The through hole 21 is formed on the concave plane 211. The mounting column is arranged on the edge of the concave plane 211, and the mounting hole 12 is arranged on the inside edge of the flange of the base 1. In this way, the structure is more reasonable, concise and smooth, and is convenient for installation, disassembly and transportation.

There is a gap between the bottom of the feeding control insert 3 and the edge of the through hole 21, so that the feeding control insert 3 still may be rotated after being inserted into the through hole 21.

The feeding control insert 3 is an elastic insert, with certain elasticity, made of silica gel or TPR or other soft material.

A plurality of small holes, configured to spread a smell, are formed on the surface of part or all of the feeding control inserts 3; and the feeding control insert 3 is not limited to a specific shape, and instead it may be in a shape of fishtail, bone or plant.

The shape of the through hole 21 can be matched with that of the feeding control insert 3.

The feeding control dish 2 and the base 1 are both made of hard material which may be melamine, plastic and the like.

The bottom of the base 1 is provided with a plurality of non-slip mats 4 made of silicone rubber material for preventing the base from moving during the pets' eating or playing.

When in use, when the plurality of feeding control inserts 3 are inserted into the feeding control dish 2, pet food, such as catnip giving off a smell, is placed into the food tray 13 of the base 1 first, and then the feeding control dish 2 is placed and fixed onto the base 1, so that the smell may be spread from the small holes on the feeding control inserts 3, thereby attracting pets to come over for eating and playing. By placing food on the feeding control dish 2, due to obstruction of the feeding control inserts 3, the mouth of the pet cannot access to the feeding control dish 2, and the pet may have smaller bites by its tongue, thereby effectively slowing down the eating speed of the pets. Meanwhile, there is a certain gap between the feeding control insert 3 and the feeding control dish 2, so that the feeding control insert 3 may be rotated, and the pet may rotate the feeding control insert 3 by its claws or mouth to adjust the gap between the feeding control insert 3 and the through hole 21. In this way, the pet may eat more or less food. In order to eat more food, the pet will find more ways to adjust the feeding control insert 3. Thus, the feeding control is realized, and also the intelligence of pets is trained. The height of the feeding control insert 3 is designed scientifically according to the biological function of the pets for eating, so that the pets will not feel bored during eating. The height of the feeding control insert 3 is 2 cm to 6 cm, preferably about 4 cm, which height having the best effect and the widest application.

When the feeding control insert 3 is a concave plane 211 and the scratching post 22 is mounted on the concave plane, objects such as catnip and snacks giving off a smell are placed inside the base 1, the through holes are formed on the concave plane 211, and the paper board is advantageous to spread a smell due to its small density. In this way, animals such as cats are easily attracted by the smell to sharpen their claws and play.

The inventive device may also be provided with a light emitting or sound generating ball, the ball rolls on the track of the annular groove, and the diameter of the track is smaller than that of the ball. In this way, the ball would not drop during rolling.

The foregoing embodiments which have been described specifically and in detail are merely several implementations of the present invention, and shall not be regarded as limitations to the scope of the invention patent. It should be noted that, for a person of ordinary skill in the art, various variations and improvements may be made to the present invention without departing from the concept of the present invention, and those variations and improvements shall be regarded as falling into the protection scope of the present invention. Therefore, the protection scope of the invention patent shall be subject to the appended claims.

1. A multifunctional intelligent feeding control device, comprising: a base and a feeding control dish, the feeding control dish being detachably mounted on the base, an edge of the base fastened with the feeding control dish being a flange; an accommodating space is formed between the feeding control dish and the base which are well mounted; at least one through hole is arranged on the feeding control dish; and a connecting member with a ventilation function is provided above and also connected to the feeding control dish.

2. The multifunctional intelligent feeding control device according to claim 1, wherein a turnup, which is folded upward, is provided on the periphery of the base for preventing food from dropping.

3. The multifunctional intelligent feeding control device according to claim 2, wherein an annular groove is formed between the flange and the turnup, the annular groove being used as a ball rolling track for toys to roll thereon.

4. The multifunctional intelligent feeding control device according to claim 1, wherein the base and the feeding control dish are both made of hard material which is melamine or plastic.

5. The multifunctional intelligent feeding control device according to claim 1, wherein the bottom of the base is provided with a plurality of non-slip mats made of silicone rubber material for preventing the base from moving during the pets' eating or playing.

6. The multifunctional intelligent feeding control device according to claim 1, wherein the connecting member is a scratching post, the feeding control dish is a concave plane having a check ring on an edge thereof, and the scratching post is mounted on the concave plane.

7. The multifunctional intelligent feeding control device according to claim 1, wherein the connecting member comprises at least one feeding control insert; the feeding control dish is a plane, and the feeding control insert is respectively arranged in the through hole; and a plurality of small holes, configured to spread a smell, are formed on the surface of the feeding control insert.

8. The multifunctional intelligent feeding control device according to claim 1, wherein the connecting member comprises at least one feeding control insert; the feeding control dish is a concave plane having a check ring on an edge thereof; the feeding control insert is respectively arranged in the through hole; and a plurality of small holes, configured to spread a smell, are formed on the surface of the feeding control insert.

9. The multifunctional intelligent feeding control device according to claim 7, wherein there is a gap between the bottom of the feeding control insert and the edge of the through hole, so that the feeding control insert still can be rotated after being inserted into the through hole.

10. The multifunctional intelligent feeding control device according to claim 7, wherein the feeding control insert is an elastic insert prepared from silica gel or TPR soft material.

11. The multifunctional intelligent feeding control device according to claim 7, wherein the feeding control insert is in a shape of fishtail, bone or plant.

12. The multifunctional intelligent feeding control device according to claim 1, wherein at least one mounting column is arranged at the back of the feeding control dish, and at least one mounting hole is arranged on the surface of the base; the mounting column and the mounting hole are mounted and connected correspondingly.

13. The multifunctional intelligent feeding control device according to claim 6, wherein at least one mounting column is provided on the back of the feeding control dish, and at least one mounting hole is formed on the surface of the base; the mounting column is arranged on the edge of the concave plane, and the mounting hole is arranged on the inside edge of the flange of the base; and the mounting column and the mounting hole are mounted and connected correspondingly.
